(19) United States
(12) Patent Application Publication
(10) Pub. No.: US 2011/0095981 A1
(43) Pub. Date: Apr. 28, 2011

(54) MINIATURE INPUT APPARATUS

(76) Inventor: Ryan Luo, Taoyuan (TW)

(21) Appl. No.: 12/913,773

(22) Filed: Oct. 28, 2010

(30) Foreign Application Priority Data
Oct. 28, 2009 (TW) 098219908

(51) Int. Cl. G06F 3/033

(52) U.S. Cl. 345/163

(57) ABSTRACT

A miniature input apparatus communicates with an electronic system having a display screen. The miniature input apparatus includes a body, a first input unit, a second input unit and a motion sensor. The body includes a top surface having a long edge and a short edge adjacent to the long edge. The first input unit and the second input unit are disposed on the top surface and arranged along the long edge. An activation of the first input unit or an activation of the second input unit corresponds to a display image of the display screen. The motion sensor is disposed inside the body for translating movement of the body into a corresponding movement of an object display on the display screen.

### BACKGROUND OF THE INVENTION

1. Field of the Invention

The invention relates to a miniature input apparatus, and more particularly, to a miniature input apparatus capable of being operated without being held by a user's hand.

2. Description of the Prior Art

A hand-held mouse is an important tool for a user to operate a computer with a hand. Therefore, the hand-held mouse becomes an essential input apparatus for all kinds of computers.

Please refer to FIG. 1. FIG. 1 is a schematic diagram illustrating a conventional mouse 1. A user's hand needs to attach on a body of the mouse 1 to move with the mouse 1 during operation. However, an identical mouse is not suitable for every user to operate due to different palm shapes or different finger lengths of different users.

Furthermore, the mouse becomes miniature with new advances in technology and convenience demand. A miniature mouse is easier to carry, but it is not convenient for a user to hold due to decreasing contact area between the surface of the miniature mouse and the user's palm. Moreover, a research report had pointed out that the smaller mouse a user uses, the easier for the user to feel uncomfortable in hands.

### SUMMARY OF THE INVENTION

The present invention provides a miniature input apparatus for communicating with an electronic system having a display screen.

According to the claimed invention, a miniature input apparatus includes a body, a first input unit, a second input unit and a motion sensor. The body includes a top surface having a long edge and a short edge adjacent to the long edge. The first input unit is disposed on the top surface of the body. An activation of the first input unit corresponds to a display image of the display screen. The second input unit is disposed on the top surface of the body. The first input unit and the second input unit are arranged along the long edge. An activation of the second input unit corresponds to the display image of the display screen. The motion sensor is disposed inside the body for translating movement of the body into a corresponding movement of an object displayed on the display screen.

According to the claimed invention, the miniature input apparatus further includes a third input unit disposed between the first input unit and the second input unit, wherein the first input unit and the second input unit are keyswitches.

According to the claimed invention, the first input unit includes a contact surface having an indentation portion.

According to the claimed invention, the second input unit includes a contact surface having an indentation portion.

According to the claimed invention, the third input unit includes a rolling member, and an activation of the rolling member corresponds to the display image of the display screen.

According to the claimed invention, the third input unit includes a touch sensor, and an activation of the touch sensor corresponds to the display image of the display screen.

According to the claimed invention, the third input unit includes a spring-back switch, and an activation of the spring-back switch corresponds to the display image of the display screen.

According to the claimed invention, the third input unit includes two rolling members and a track engaged with the two rolling members, and an activation of the track corresponds to the display image of the display screen.

According to the claimed invention, the first input unit, the second input unit, and the third input unit are for being operated with an index finger, a middle finger, and a ring finger correspondingly.

According to the claimed invention, the motion sensor is located on a bottom of the body and is located under the first input unit or the second input unit.

According to the claimed invention, the motion sensor is an optical sensor.

According to the claimed invention, the top surface of the body is a rectangular surface having two opposite long edges, and the first input unit and the second input unit are disposed between the two long edges and arranged along the two long edges.

According to the claimed invention, the miniature input apparatus is for being operated by a user's hand and the user's palm is not supported by the miniature input apparatus during operation.

According to the claimed invention, the object displayed on the display screen is a mouse cursor or an icon.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a conventional mouse.

FIG. 2A is a top view illustrating a miniature input apparatus according to a first embodiment of the present invention.

FIG. 2B is a cross-sectional diagram illustrating the miniature input apparatus along A-A′ line in FIG. 2A.

FIG. 2C is a cross-sectional diagram illustrating a first input unit and a second input unit respectively having indentation portions.

FIG. 2D is a schematic diagram illustrating the miniature input apparatus being operated by a hand.

FIG. 3 is a top view illustrating a miniature input apparatus according to a second embodiment of the present invention.

FIG. 4A is a top view illustrating a miniature input apparatus according to a third embodiment of the present invention.

FIG. 4B is a cross-sectional diagram illustrating the miniature input apparatus along B-B′ line in FIG. 4A.

FIG. 5A is a top view illustrating a miniature input apparatus according to a fourth embodiment of the present invention.

FIG. 5B is a cross-sectional diagram illustrating the miniature input apparatus along C-C′ line in FIG. 5A.

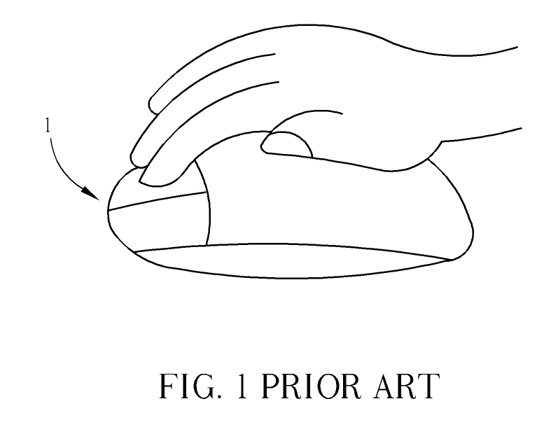

### DETAILED DESCRIPTION

The present invention provides a miniature input apparatus for communicating with an electronic system having a display screen. In the following embodiments, the miniature input apparatus can be a mouse for communicating with a desktop computer or a notebook computer. In practical application, the miniature input apparatus can communicate with an electronic system by wires or wireless communication.

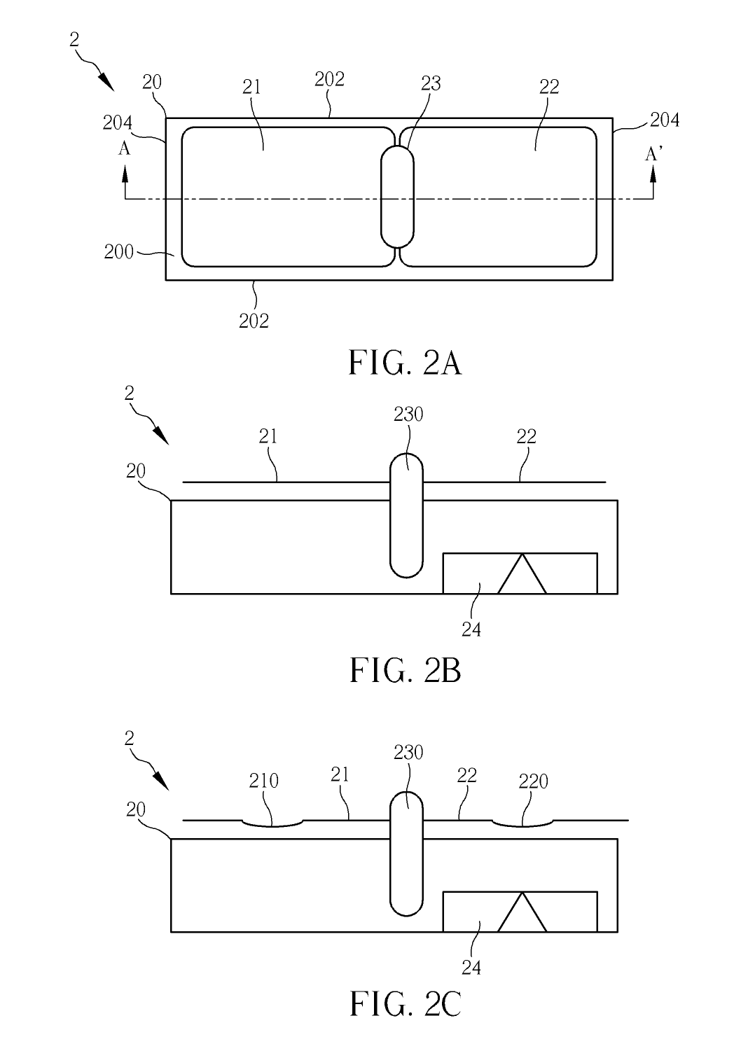

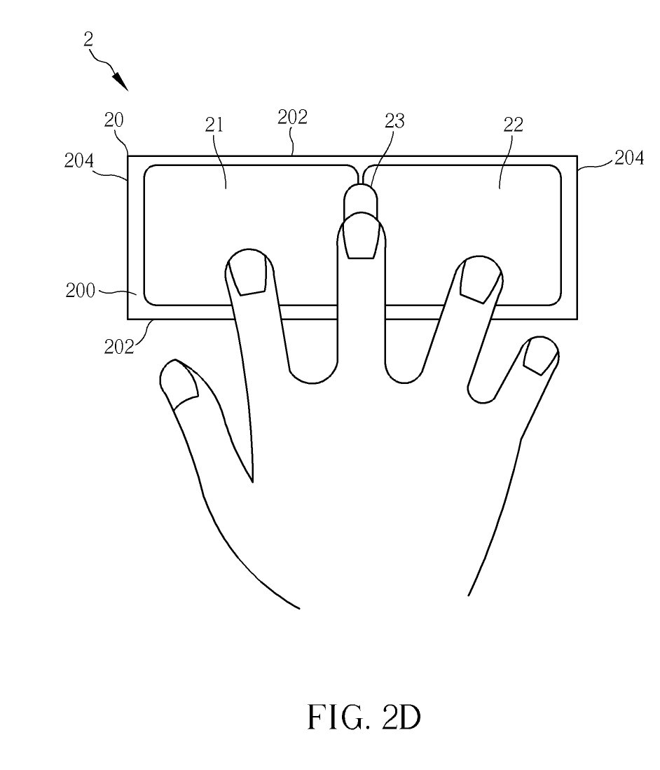

Please refer to FIG. 2A and FIG. 2B. FIG. 2A is a top view illustrating a miniature input apparatus 2 according to a first embodiment of the present invention. FIG. 2B is a cross-sectional diagram illustrating the miniature input apparatus 2 along A-A′ line in FIG. 2A.

As shown in FIG. 2A and FIG. 2B, the miniature input apparatus 2 includes a body 20, a first input unit 21, a second input unit 22, a third input unit 23 and a motion sensor 24. In an embodiment, the body 20 can be, but not limited to, a rectangular block. Besides, the body 20 has a top surface 200.

As for the rectangular block, the top surface 200 of the body 20 can be a rectangular surface. The rectangular surface has two opposite long edges 202 and two opposite short edges 204. The two opposite long edges 202 are adjacent to the two opposite short edges 204. The two opposite long edges 202 and the two opposite short edges 204 form the rectangular surface.

It should be noted that the first input unit 21, the second input unit 22 and the third input unit 23 are disposed on the top surface 200 of the body 20. As shown in FIG. 2A, the first input unit 21, the second input unit 22 and the third input unit 23 are disposed between the two long edges 202 and arranged along the two long edges 202.

In an embodiment, the third input unit 23 is disposed between the first input unit 21 and the second input unit 22, and the first input unit 21 and the second input unit 22 are keyswitches. For example, the first input unit 21 can be taken as a left keyswitch and the second input unit 22 can be taken as a right keyswitch in a conventional mouse. As shown in FIG. 2B, the first input unit 21 and the second input unit 22 respectively include a contact surface for a user's fingers to press. Please refer to FIG. 2C. FIG. 2C is a cross-sectional diagram illustrating the first input unit 21 and the second input unit 22 respectively having indentation portions 210, 220. As shown in FIG. 2C, the contact surface of first input unit 21 and the contact surface of the second input unit 22 respectively have the indentation portions 210, 220. The indentation portions 210, 220 are respectively located on a central area of the contact surfaces. A user's fingers can put on the indentation portions 210, 220 to prevent the fingers slipping on the contact surface, so as to click the first input unit 21 and the second input unit 22 effectively.

When the miniature input apparatus 2 communicates with an electronic system having a display screen, an activation of the first input unit 21 and an activation of the second input unit 22 correspond to a display image displayed on the display screen. For example, the miniature input apparatus 2 can control a movement of a mouse cursor on the display screen. When a user moves a mouse cursor onto an icon and activates the first input unit 21 (such as clicking it), the display screen will display a display image that the icon is selected. In another example, when a user clicks the second input unit 22 on the desktop of WINDOWS® operating system, the display screen will display a frame of a pop-up function table.

A motion sensor 24 is disposed inside the body 20 for translating movement of the body 20 into a corresponding movement of an object displayed on the display screen. For example, the object displayed on the display screen can be a mouse cursor or an icon moving with the corresponding movement of the body 20. In practical application, the motion sensor 24 can be an optical sensor or other position sensor of the mechanical type. It should be noted that the motion sensor 24 can be located on a bottom of the body 20 and is located under the first input unit 21 or the second input unit 22, so as to decrease total height of the miniature input apparatus 2.

As shown in FIG. 2B, the third input unit 23 can include a rolling member 230, and the third input unit 23 is disposed between the first input unit 21 and the second input unit 22. An activation of the rolling member 230 corresponds to the display image displayed on the display screen when operating the rolling member 230. For example, when a user rolls the rolling member 230 to surf a webpage, the display screen will display a display image that the webpage is rolled. Furthermore, the motion sensor 24 can be disposed beside the rolling member 230 instead of being disposed under the rolling member 230, so as to decrease total height of the miniature input apparatus 2, such that total volume of the miniature input apparatus 2 is decreased as well.

Please refer to FIG. 2D. FIG. 2D is a schematic diagram illustrating the miniature input apparatus 2 being operated by a hand. In an embodiment, the first input unit 21, the second input unit 22, and the third input unit 23 can be for being operated with an index finger, a middle finger, and a ring finger correspondingly, but it is not limited to the embodiment mentioned above. In practical application, a user can operate the first input unit 21, the second input unit 22, and the third input unit 23 by his/her habitual fingers.

It should be noted that a user's palm can not be supported by the miniature input apparatus 2 when operating the miniature input apparatus 2. Compared to the prior art, a user's hand can stay close to the desktop to move when operating the miniature input apparatus 2. Therefore, a user can adjust his/her gesture for an ergonomically comfortable operation of the first input unit 21, the second input unit 22, and the third input unit 23. Accordingly, the miniature input apparatus 2 of the present invention can bring preferred serviceability for users regarding ergonomics.

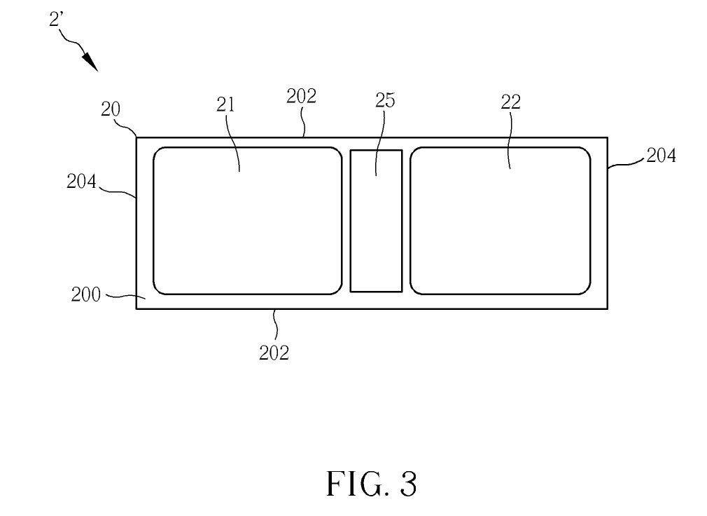

Please refer to FIG. 3. FIG. 3 is a top view illustrating a miniature input apparatus 2′ according to a second embodiment of the present invention. In this embodiment, a third input unit 25 includes a touch sensor (such as a capacitive type sensor and so on), and the third input unit 25 is disposed between the first input unit 21 and the second input unit 22. An activation of the touch sensor corresponds to the display image displayed on the display screen. For example, when a user's finger moves on the touch sensor for surfing a webpage, the display screen will display a display image that the webpage is rolled.

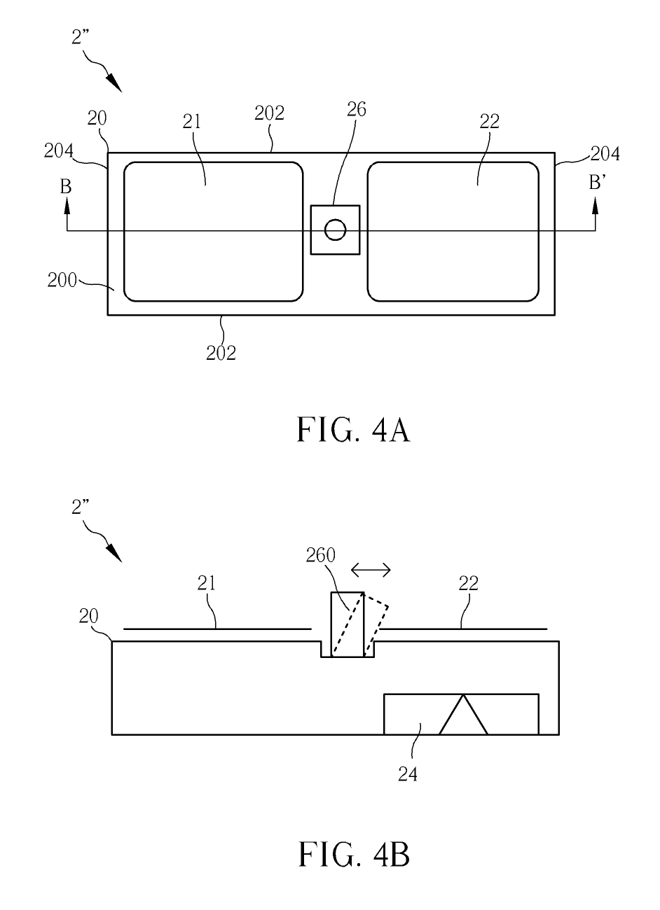

Please refer to FIG. 4A and FIG. 4B. FIG. 4A is a top view illustrating a miniature input apparatus 2″ according to a third embodiment of the present invention. FIG. 4B is a cross-sectional diagram illustrating the miniature input apparatus 2″along B-B′ line in FIG. 4A. In this embodiment, a third input unit 26 includes a spring-back switch 260, and the third input unit 26 is disposed between the first input unit 21 and the second input unit 22. As shown in FIG. 4B, the spring-back switch 260 can be a multidirectional joystick. The joystick can return back to the original position after a pushing force is released. As shown in FIG. 4B, the joystick is pushed to the right. The joystick can return back to the central position after releasing. An activation of the spring-back switch 260 corresponds to the display image displayed on the display screen. For example, when a user's finger pushes the joystick back and forth for surfing a webpage, the display screen will display a display image that the webpage is rolled.

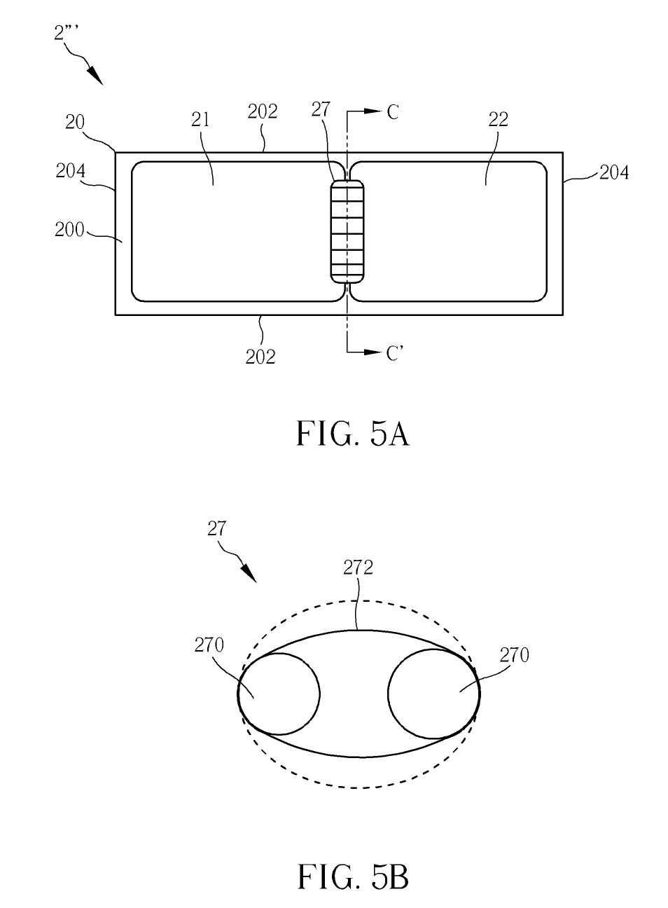

Please refer to FIG. 5A and FIG. 5B. FIG. 5A is a top view illustrating a miniature input apparatus 2′″ according to a fourth embodiment of the present invention. FIG. 5B is a cross-sectional diagram illustrating the miniature input apparatus 2′″ along C-C′ line in FIG. 5A. In this embodiment, a third input unit 27 can include two rolling members 270 and a track 272 engaged with the two rolling members 270, and the third input unit 27 is disposed between the first input unit 21 and the second input unit 22. It should be noted that the dash line of FIG. 5B represents a contour of a roller in a conventional mouse. The objective of the third input unit 27 utilizing the two rolling members 270 and the track 272 is to decrease total height of the miniature input apparatus 2′″ comparing with the conventional mouse, such that total volume of the miniature input apparatus 2′″ is decreased as well. An activation of the track 272 can correspond to the display image displayed on the display screen. For example, when a user's finger rolls the track back and forth for surfing a webpage, the display screen will display a display image that the webpage is rolled.

As mentioned in the above, the present invention provides a miniature input apparatus capable of being carried easily. It must be emphasized that a user's hand can stay close to a desktop to move as his/her wish when operating the miniature input apparatus. It is unlike the conventional mouse that a user's hand needs to attach on the mouse. A user will feel uncomfortable when the size of the mouse can not fit the user's hand. Compared to the prior art, a user can adjust his/her gesture for an ergonomically comfortable operation of the miniature input apparatus of the present invention. Therefore, the miniature input apparatus of the present invention can bring preferred serviceability for users regarding ergonomics.

Those skilled in the art will readily observe that numerous modifications and alterations of the device and method may be made while retaining the teachings of the invention.

What is claimed is:

1. A miniature input apparatus for communicating with an electronic system having a display screen, the miniature input apparatus comprising:
a body comprising a top surface having a long edge and a short edge adjacent to the long edge;
a first input unit disposed on the top surface of the body, an activation of the first input unit corresponding to a display image of the display screen;
a second input unit disposed on the top surface of the body, the first input unit and the second input unit being arranged along the long edge, and an activation of the second input unit corresponding to the display image of the display screen; and
a motion sensor disposed inside the body for translating movement of the body into a corresponding movement of an object displayed on the display screen.

2. The miniature input apparatus of claim 1, further comprising a third input unit disposed between the first input unit and the second input unit, wherein the first input unit and the second input unit are keyswitches.

3. The miniature input apparatus of claim 2, wherein the first input unit comprises a contact surface having an indentation portion.

4. The miniature input apparatus of claim 2, wherein the second input unit comprises a contact surface having an indentation portion.

5. The miniature input apparatus of claim 2, wherein the third input unit comprises a rolling member, and an activation of the rolling member corresponds to the display image of the display screen.

6. The miniature input apparatus of claim 2, wherein the third input unit comprises a touch sensor, and an activation of the touch sensor corresponds to the display image of the display screen.

7. The miniature input apparatus of claim 2, wherein the third input unit comprises a spring-back switch, and an activation of the spring-back switch corresponds to the display image of the display screen.

8. The miniature input apparatus of claim 2, wherein the third input unit comprises two rolling members and a track engaged with the two rolling members, and an activation of the track corresponds to the display image of the display screen.

9. The miniature input apparatus of claim 2, wherein the first input unit, the second input unit, and the third input unit are for being operated with an index finger, a middle finger, and a ring finger correspondingly.

10. The miniature input apparatus of claim 1, wherein the motion sensor is located on a bottom of the body and is located under the first input unit or the second input unit.

11. The miniature input apparatus of claim 1, wherein the motion sensor is an optical sensor.

12. The miniature input apparatus of claim 1, wherein the top surface of the body is a rectangular surface having two opposite long edges, and the first input unit and the second input unit are disposed between the two long edges and arranged along the two long edges.

13. The miniature input apparatus of claim 1, wherein the miniature input apparatus is for being operated by a user's hand and the user's palm is not supported by the miniature input apparatus during operation.

14. The miniature input apparatus of claim 1, wherein the object displayed on the display screen is a mouse cursor or an icon.
